(19) United States
(12) Patent Application Publication
(10) Pub. No.: US 2014/0348334 A1
(43) Pub. Date: Nov. 27, 2014

(54) PORTABLE TERMINAL AND METHOD FOR DETECTING EARPHONE CONNECTION

(71) Applicant: SAMSUNG ELECTRONICS CO., LTD., GYEONGGI-DO (KR)

(72) Inventors: Han-Ho KO, Seoul (KR); Sung-Hoon Jeong, Gyeonggi-do (KR); Je-Heon Park, Gyeonggi-do (KR); Yoon-Gu Choi, Gyeonggi-do (KR)

(73) Assignee: SAMSUNG ELECTRONICS CO., LTD., GYEONGGI-DO (KR)

(21) Appl. No.: 14/283,829

(22) Filed: May 21, 2014

(30) Foreign Application Priority Data
May 23, 2013 (KR) 10-2013-0058361

(51) Int. Cl. H04R 29/00

(52) U.S. Cl. CPC H04R 29/00
USPC 381/58

(57) ABSTRACT

A portable terminal and a method for detecting an earphone connection are provided. The method includes detecting a connection of earphones; detecting and analyzing a sound input through the connected earphones; and determining whether a microphone is installed in the earphones by comparing an analysis result with a first predetermined threshold.

### PRIORITY

This application claims priority under 35 U.S.C. §119(a) to Korean Patent Application Serial No. 10-2013-0058361, which was filed in the Korean Intellectual Property Office on May 23, 2013, the entire content of which is incorporated herein by reference.

### BACKGROUND

1. Field of the Invention

The present invention generally relates to a portable terminal, and more particularly, to a portable terminal and a method for detecting an earphone connection.

2. Description of the Related Art

In recent years, various services and additional functions that a portable terminal provides are gradually increasing in use. In order to increase an effective value of the portable terminal and meet various demands of users, communication service providers or portable terminal manufacturers have provided more diverse functions and competitively developed portable terminals which are different from those of other companies. Due to such competitive development, the portable terminal can provide users with various services, such as Internet access, email transmission/reception, camera, wireless Internet service, music and reproduction of a multimedia including a movie, beyond a conventional voice call.

The user can receive a multimedia service without any restraint on time and space through the portable terminal having a function of reproducing multimedia, such as a dynamic image and music. When the user receives such a multimedia service, the user generally connects earphones to the portable terminal so as not to bother people around the user. The earphones may have a speaker outputting a sound and a microphone receiving an input of a sound. When the earphones are inserted into an earphone connecting jack, the portable terminal detects the insertion of the earphones and controls to output a sound through the earphones. A method in which the portable terminal detects the microphone of the earphones may include a method using a comparator and an Analog to Digital Converter (ADC) method. The method using the comparator corresponds to a method of detecting the insertion of the earphones by using a low signal when the earphones are inserted, and the ADC method corresponds to a method of converting an input analog voice signal to a digital signal and detecting the digital signal.

However, the method using the comparator has a problem in which a malfunction of the microphone included in the earphones cannot be detected, and the ADC method has a problem in which large current consumption is generated and it takes a lot of time to detect an earphone jack.

### SUMMARY

The present invention has been made to address the above problems and disadvantages, and to provide at least the advantages described below. Accordingly, an aspect of the present invention is to provide a portable terminal and a method for detecting an earphone connection which can determine whether inserted earphones normally operate by analyzing a sound input through the microphone included in the earphones.

In accordance with an aspect of the present invention, a method of detecting an earphone connection by a portable terminal is provided. The method includes detecting a connection of earphones; detecting and analyzing a sound input through the connected earphones; and determining whether a microphone is installed in the earphones by comparing an analysis result with a first predetermined threshold.

In accordance with another aspect of the present invention, a portable terminal detecting an earphone connection is provided. The portable terminal includes an earphone connecting jack configured to connect the portable terminal and earphones; and a controller configured to detect and analyze a sound input through the connected earphones, and to determine whether a microphone is installed in the earphones by comparing an analysis result with a first predetermined threshold.

In accordance with another aspect of the present invention, a method of detecting an earphone connection by a portable terminal is provided. The method includes detecting an insertion of an earphones jack of earphones having a microphone into an earphone connecting jack; detecting and analyzing a sound input through the microphone of the inserted earphones; and determining whether the microphone normally operates by comparing an analysis result with a predetermined threshold.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a configuration of a portable terminal according to an embodiment of the present invention;

FIG. 2 illustrates a front perspective view of a portable terminal according to an embodiment of the present invention;

FIG. 3 illustrates a rear perspective view of a portable terminal according to an embodiment of the present invention;

FIG. 4 is an internal cross-sectional view of an input unit and a touch screen according to an embodiment of the present invention;

FIG. 5 is a block diagram illustrating an input unit according to an embodiment of the present invention;

FIG. 6 is a flowchart illustrating a process in which a portable terminal determines whether earphones normally operate according to an embodiment of the present invention;

FIG. 7 illustrates an example of a structure of an earphone jack according to an embodiment of the present invention;

FIG. 8A illustrates an example of outputting a normal operation of a microphone installed in earphones according to an embodiment of the present invention; and

FIG. 8B illustrates an example of outputting an abnormal operation of a microphone installed in earphones according to an embodiment of the present invention.

### DETAILED DESCRIPTION OF EMBODIMENTS OF THE PRESENT INVENTION

The present invention may have various modifications and various embodiments, among which specific embodiments will now be described more fully with reference to the accompanying drawings. However, it should be understood that there is no intent to limit the present invention to the specific embodiments, but on the contrary, the present invention covers all modifications, equivalents, and alternatives falling within the scope of the invention.

Although the terms including an ordinal number such as first, second, etc. can be used for describing various elements, the elements are not restricted by the terms. The terms are only used to distinguish one element from another element. For example, without departing from the scope of the present invention, a first structural element may be referred to as a second structural element. Similarly, the second structural element also may be referred to as the first structural element. As used herein, the term “and/or” includes any and all combinations of one or more of the associated listed items.

The terms used in this application are for the purpose of describing particular embodiments only and are not intended to limit the invention. Singular forms are intended to include plural forms unless the context clearly indicates otherwise. In the description, it should be understood that the terms “include” or “have” indicate existences of a feature, a number, a step, an operation, a structural element, parts, or a combination thereof, and do not previously exclude the existences or probability of addition of one or more another features, numeral, steps, operations, structural elements, parts, or combinations thereof.

Unless defined differently, all terms used herein, which include technical terminologies or scientific terminologies, have the same meaning as understood by a person skilled in the art to which the present invention belongs. It should be interpreted that the terms, which are identical to those defined in general dictionaries, have the meaning identical to that in the context of the related technique. The terms should not be ideally or excessively interpreted as a formal meaning.

Hereinafter, an operation principle of embodiments of the present invention will be described in detail with reference to the accompanying drawings. A detailed description of known functions and configurations incorporated herein will be omitted as it may make the subject matter of the present invention unclear. The terms which will be described below are terms defined in consideration of the functions in the present invention, and may be different according to users, intentions of the users, or customs. Therefore, the definitions need to be determined based on the overall contents of the present specification.

The term “portable terminal” refers to a portable terminal which is portable and enables data transmission/reception and a voice and video call, and may include one or more touch screens. The portable terminal includes a smart phone, a tablet Personal Computer (PC), a 3D-TeleVision (TV), a smart TV, a Light Emitting Diode (LED) TV, and a Liquid Crystal Display (LCD) TV, and also includes a terminal which can communicate with a neighboring device or another terminal located at a remote place.

The term “input unit” includes at least one of a finger, an electronic pen and a stylus pen which can provide a command or an input to the portable terminal in a screen contact state or a non-contact state such as hovering.

According to the present invention, it is possible to more quickly determine whether a microphone exists in earphones or whether the microphone normally operates by analyzing a sound input through the earphones.

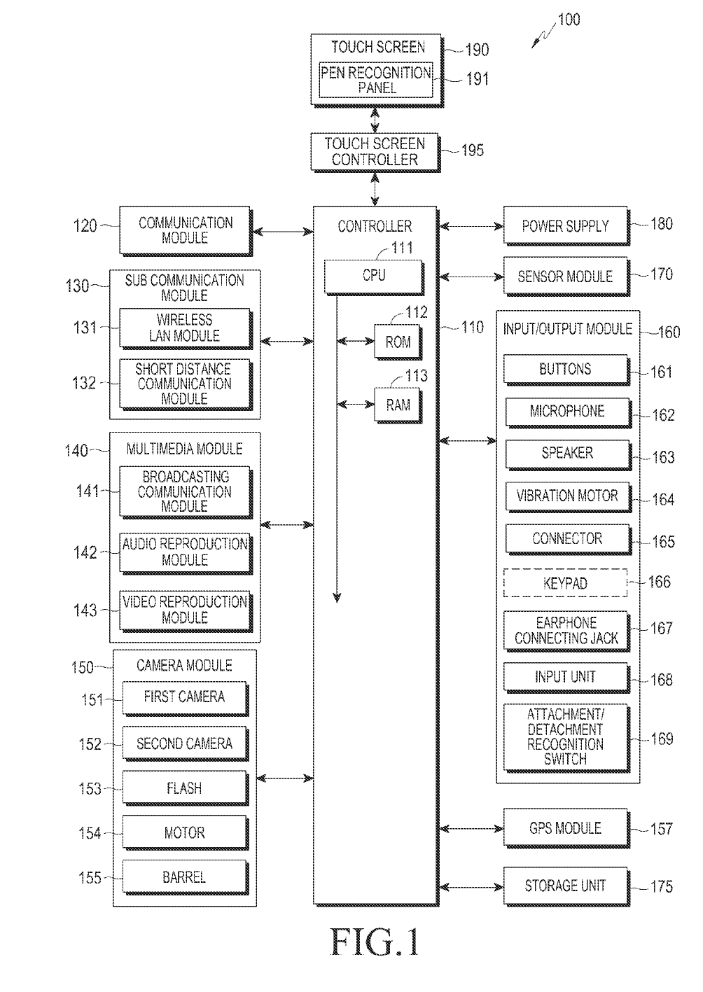

FIG. 1 is a block diagram illustrating a configuration of a portable terminal according to an embodiment of the present invention.

Referring to FIG. 1, a portable terminal 100 is connected with an external device by using one of a mobile communication module 120, a sub-communication module 130, a connector 165, and an earphone connecting jack 167. The external device includes various devices detachably attached to the portable terminal 100 by a wire, such as earphones, an external speaker, a Universal Serial Bus (USB) memory, a charger, a cradle/dock, a Digital Multimedia Broadcasting (DMB) antenna, a mobile payment related device, a health management device (e.g., blood sugar tester, or the like), a game machine, a car navigation device, and the like. Further, the portable terminal may include a Bluetooth communication device, a Near Field Communication (NFC) device, a WiFi Direct communication device, and a wireless Access Point (AC) which can wirelessly access a network. The portable terminal may be connected with other devices, for example, a mobile phone, a smart phone, a tablet Personal Computer (PC), a desktop PC, and a server in a wired or wireless manner.

Referring to FIG. 1, the portable terminal 100 includes at least one touch screen and at least one touch screen controller 195. Also, the portable terminal 100 includes a controller 110, a mobile communication module 120, a sub-communication module 130, a multimedia module 140, a camera module 150, a Global Positioning System (GPS) module 157, an input/output module 160, a sensor module 170, a storage unit 175, and a power supply 180.

The sub communication module 130 includes at least one of a wireless Local Area Network (LAN) module 131 and a short range communication module 132. The multimedia module 140 includes at least one of a broadcasting communication module 141, an audio reproduction module 142, and a video reproduction module 143. The camera module 150 includes at least one of a first camera 151 and a second camera 152. Further, the camera module 150 may include at least one of a barrel 155 for zooming in/zooming out the first and/or second cameras 151 and 152, a motor 154 for controlling a motion of the barrel 155 to zoom in/zoom out the barrel 155, and a flash 153 for providing a light source for photographing according to a main purpose of the portable terminal 100. The input/output module 160 includes at least one of a button 161, a microphone 162, a speaker 163, a vibration motor 164, a connector 165, and a keypad 166.

The controller 110 includes a Central Processing Unit (CPU) 111, a Read Only Memory (ROM) 112 which stores control programs for controlling the user terminal 100, and a Random Access Memory (RAM) 113 which stores signals or data input from the outside of the portable terminal 100 or is used as a memory region for an operation executed in the portable terminal 100. The CPU 111 includes a single core, a dual core, a triple core, or a quadruple core. The CPU 111, the ROM 112 and the RAM 113 are connected to each other through internal buses.

The controller 110 controls the mobile communication module 120, the sub communication module 130, the multimedia module 140, the camera module 150, the input/output module 160, the sensor module 170, the storage unit 175, the power supplier 180, the touch screen 190, and the touch screen controller 195.

The controller 110 detects various user inputs received through the camera module 150, the input/output module 160, and the sensor module 170 as well as the touch screen 190. The user input includes various types of information input into the portable terminal 100, such as a gesture, a voice, a pupil action, and a bio signal of the user as well as the touch. The controller 110 controls to perform a predetermined operation or function corresponding to the detected user input within the portable terminal 100.

The controller 110 determines whether a hovering is recognized as a touch input unit 168 such as an electronic pen approaches one object when a plurality of objects are displayed on the touch screen 190 or a touch by the input unit 168 is detected on the touch screen 190. In addition, the controller 110 detects a distance between the portable terminal 100 and the input unit 168 and a hovering input according to the distance. That is, the controller 110 detects a hovering input generated on the touch screen 190 by the input unit 168 or a touch input generated on the touch screen 190 by the input unit 168.

The controller 110 detects whether there is a connection between the earphone connecting jack 167 of the portable terminal 100 and the earphones or the microphone of the earphones, and detects and analyzes a sound input through the connected earphones. That is, when the earphones are connected, the controller 110 activates a module that detects a sound input through the microphone included in the earphones. Further, the controller 110 determines whether the earphones include the microphone by comparing a result of the analysis with a predetermined threshold. The controller 110 calculates at least one of a peak value, a current value, a Signal to Noise Ratio (SNR), and Root Mean Square (RMS) of the detected sound. When the analysis result exceeds the predetermined threshold, the controller 110 determines that the microphone is included in the earphones. When the analysis result does not exceed the predetermined threshold, the controller 110 determines that the microphone is not included in the earphones. Further, when the analysis result exceeds the predetermined threshold, the controller 110 analyzes whether the microphone normally operates. The controller 110 allows the user to know the analysis result in various ways, such as a sound output through earphones and a popup window on the touch screen 190.

The mobile communication module 120 enables the portable terminal 100 to be connected with the external device through mobile communication by using one or more antennas according to a control of the controller 110. The mobile communication module 120 transmits/receives a wireless signal for a voice call, a video call, a Short Message Service (SMS), or a Multimedia Message Service (MMS) to/from a mobile phone, a smart phone, a tablet PC, or another device, which has a phone number input into the portable terminal 100.

The sub-communication module 130 includes at least one of the wireless LAN module 131 and the short-range communication module 132. For example, the sub-communication module 130 includes only the wireless LAN module 131, only the short-range communication module 132, or both the wireless LAN module 131 and the short-range communication module 132.

The wireless LAN module 131 is connected to the Internet in a place where a wireless Access Point (AP) is installed, under a control of the controller 110. The wireless LAN module 131 supports a wireless LAN standard (IEEE802.11x) of the Institute of Electrical and Electronics Engineers (IEEE). The short-range communication module 132 performed local area communication wirelessly between the portable terminal 100 and an image forming apparatus according to the control of the controller 110. A short-range communication scheme includes a Bluetooth communication scheme, an Infrared Data Association (IrDA) communication scheme, a WiFi-Direct communication scheme, a Near Field Communication (NFC) scheme and the like.

According to the performance, the portable terminal 100 may include at least one of the mobile communication module 120, the wireless LAN module 131, and the local area communication module 132. Further, according to the performance, the portable terminal 100 may include a combination of the mobile communication module 120, the wireless LAN module 131, and the local area communication module 132. In describing the present invention, at least one or a combination of the mobile communication module 120, the wireless LAN module 131, and the short-range communication module 132 are referred to as a transmitter/receiver, without being limited thereto.

The multimedia module 140 includes the broadcasting communication module 141, the audio reproduction module 142, or the video reproduction module 143. The broadcasting communication module 141 receives a broadcasting signal (e.g., a TV broadcasting signal, a radio broadcasting signal or a data broadcasting signal) or broadcasting additional information (e.g., Electric Program Guide (EPS) or Electric Service Guide (ESG)) which are transmitted from a broadcasting station, through a broadcasting communication antenna, under a control of the controller 110. The audio reproduction module 142 reproduces a stored or received digital audio file, e.g., a file having a file extension of mp3, wma, ogg, or way, under a control of the controller 110. The video reproduction module 143 reproduces a stored or received digital video file (e.g., a file of which the file extension is mpeg, mpg, mp4, avi, mov, or mkv) under the control of the controller 110. The video reproduction module 143 may also reproduce a digital audio file.

The multimedia module 140 includes the audio reproduction module 142 and the video reproduction module 143 except for the broadcasting communication module 141. Further, the audio reproduction module 142 or the video reproduction module 143 of the multimedia module 140 may be included in the controller 110.

The camera module 150 includes at least one of the first camera 151 and the second camera 152 which photograph a still image or a moving image under the control of the controller 110. Further, the camera module 150 includes at least one of the barrel performing a zoom-in/out for photographing a subject, the motor 154 controlling a movement of the barrel 155, and the flash 153 providing an auxiliary light source required for photographing the subject. The first camera 151 is disposed on a front surface of the portable terminal 100, and the second camera 152 is disposed on a rear surface of the portable terminal 100. Alternatively, the first camera 151 and the second camera 152 are disposed to be adjacent to each other (e.g., an interval between the first camera 151 and the second camera 152 is larger than 1 centimeter and smaller than 8 centimeter) to photograph a three-dimensional still image or a three-dimensional moving image.

Each of the first and second cameras 151 and 152 includes a lens system, an image sensor, and the like. The first and second cameras 151 and 152 convert optical signals input (or taken) through the lens system into electric image signals, and output the electric image signals to the controller 110. The user takes a video or a still image through the first and second cameras 151 and 152.

The GPS module 157 receives radio waves from a plurality of GPS satellites in Earth's orbit and calculates a position of the portable terminal 100 by using Time of Arrival information from the GPS satellites to the portable terminal 100.

The input/output module 160 includes at least one of a plurality of buttons 161, the microphone 162, the speaker 163, the vibration motor 164, the connector 165, the keypad 166, the earphone connecting jack 167, and the input unit 168, but is not limited thereto. A mouse, a trackball, a joystick, or a cursor control such as cursor direction keys may be provided to control a movement of the cursor on the screen 190.

The buttons 161 are formed on the front surface, side surfaces or rear surface of the housing of the user terminal 100 and may include at least one of a power/lock button, a volume button, a menu button, a home button, a back button, and a search button 161.

The microphone 162 receives a voice or a sound to generate an electrical signal under a control of the controller 110.

The speaker 163 outputs sounds corresponding to various signals of the mobile communication module 120, the sub-communication module 130, the multimedia module 140, and the camera module 150 (e.g., a radio signal, a broadcast signal, a digital audio file, a digital video file, or photographing) to the outside of the portable terminal 100 under a control of the controller 110. The speaker 163 outputs a sound (for example, button tone corresponding to phone communication, ringing tone, and a voice of another user) corresponding to a function performed by the portable terminal 100. One or more speakers 163 may be formed on a suitable position or positions of the housing of the portable terminal 100.

The vibration motor 164 converts an electric signal into a mechanical vibration under a control of the controller 110. For example, when the portable terminal 100 in a vibration mode receives a voice call from any other device, the vibration motor 164 operates. One or more vibration motors 164 may be provided in the housing of the portable terminal 100. The vibration motor 164 operates in response to a touch action of the user on the touch screen 190 and successive motions of touches on the touch screen 190.

The connector 165 is used as an interface for connecting the portable terminal with an external device or a power source. The portable terminal 100 transmits or receives data stored in the storage unit 175 of the portable terminal 100 to or from an external device through a wired cable connected to the connector 165 according to a control of the controller 110. Further, the portable terminal 100 receives power from the power source through the wired cable connected to the connector 165 or charge a battery by using the power source.

The keypad 166 receives a key input from a user for control of the portable terminal 100. The keypad 166 includes a physical keypad formed in the portable terminal 100 or a virtual keypad displayed on the display unit 190. The physical keypad formed on the portable terminal 100 may be omitted according to the capability or configuration of the portable terminal 100.

Earphones is inserted into the earphone connecting jack 167 to be connected to the portable terminal 100, and the input unit 168 is inserted into and stored in the portable terminal 100 and may be withdrawn or detached from the portable terminal 100 when being used. In addition, an attachment/detachment recognition switch 169 operating in response to attachment or detachment of the input unit 168 is provided at one area within the portable terminal 100 into which the input unit 168 is inserted, and provides a signal corresponding to the attachment or detachment of the input unit 168 to the controller 110. The attachment/detachment recognition switch 169 is located at one area into which the input unit 168 is inserted to directly or indirectly contact the input unit 168 when the input unit 168 is mounted. Accordingly, the attachment/detachment recognition switch generates a signal corresponding to the attachment or the detachment of the input unit 168 based on the direct or indirect contact with the input unit 168 and then provides the generated signal to the controller 110.

The sensor module 170 includes at least one sensor for detecting a state of the portable terminal 100. For example, the sensor module 170 includes a proximity sensor that detects a user's proximity to the portable terminal 100, an illumination sensor that detects a quantity of light around the portable terminal 100, a motion sensor that detects a motion (e.g., rotation of the portable terminal 100 and acceleration or a vibration applied to the portable terminal 100) of the portable terminal 100, a geo-magnetic sensor that detects a point of a compass by using the Earth's magnetic field, a gravity sensor that detects an action direction of gravity, and an altimeter that detects an altitude through measuring an atmospheric pressure. At least one sensor detects the state, and generates a signal corresponding to the detection to transmit the generated signal to the controller 110. The sensor of the sensor module 170 may be added or omitted according to a capability of the portable terminal 100.

The storage unit 175 stores signals or data input/output in response to the operations of the mobile communication module 120, the sub-communication module 130, the multimedia module 140, the camera module 150, the GPS module 157, the input/output module 160, the sensor module 170, and the touch screen 190 according to the control of the controller 110. The storage unit 175 stores a control program and applications for controlling the portable terminal 100 or the controller 110.

The term “storage unit” includes the storage unit 175, the ROM 112 and the RAM within the controller 110, or a memory card (for example, an SD card or a memory stick) installed in the portable terminal 100. The storage unit may also include a nonvolatile memory, a volatile memory, a Hard Disk Drive (HDD), or a Solid State Drive (SSD).

The storage unit 175 stores applications having various functions such as a navigation function, a video call function, a game function, and a time based alarm function, images for providing a Graphical User Interface (GUI) related to the applications, databases or data related to a method of processing user information, a document, and a touch input, background images (a menu screen, an idle screen or the like) or operating programs required for driving the portable terminal 100, and images photographed by the camera module 150. The storage unit 175 is a machine (for example, computer)-readable medium. The term “machine-readable medium” is defined as a medium capable of providing data to the machine so that the machine performs a specific function. The machine-readable medium may be a storage medium. The storage unit 175 may also include a non-volatile medium and a volatile medium. All of these media should be in a tangible type that allows the commands transferred by the media to be detected by a physical instrument in which the machine reads the commands into the physical instrument.

The machine-readable medium includes at least one of a floppy disk, a flexible disk, a hard disk, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), and a flash-EPROM, but is not limited thereto.

The power supply 180 supplies power to one or more batteries provided to the portable terminal 100 under a control of the controller 110. The one or more batteries supply power to the portable terminal 100. In addition, the power supply 180 supplies, to the portable terminal 100, the power input from an external power source through a wired cable connected with the connector 165. In addition, the power supply 180 supplies power wirelessly input from the external power source through a wireless charging technology to the portable terminal 100.

The portable terminal 100 includes at least one touch screen providing user interfaces corresponding to various services (for example, a phone call, data transmission, broadcasting, and photography) to the user. Each touch screen transmits an analog signal corresponding to at least one touch input to a user interface to a corresponding touch screen controller. The portable terminal 100 includes a plurality of touch screens, and each of the touch screens is provided with a touch screen controller that receives an analog signal corresponding to a touch. Each touch screen may be connected to a plurality of housings through a hinge separately, or may be located in a single housing without a hinge connection. As described above, the portable terminal 100 may include at least one touch screen, and for convenience of description, the portable terminal 100 including one touch screen will be described hereinafter.

The touch screen 190 receives at least one touch through a user's body (for example, fingers including a thumb) or a touchable input means (for example, a stylus pen or an electronic pen). Further, when a touch is input through a pen such as a stylus pen or an electronic pen, the touch screen 190 includes a pen recognition panel 191 that recognizes the touch input, and the pen recognition panel 191 may grasp a distance between the pen and the touch screen 190 through a magnetic field. Also, the touch screen 190 receives a continuous motion of one touch among at least one touch. The touch screen 190 outputs an analog signal corresponding to the successive motions of the input touch to the touch screen controller 195.

The touch is not limited to the contact between the screen 190 and the user's body or the touchable input unit, and may include a non-contact (for example, an interval which can be detected without the contact between the screen 190 and the user's body or the touchable input unit). A detectable interval in the touch screen 190 is varied according to a performance or a structure of the portable terminal 100, and more particularly, the touch screen 190 is configured such that values detected by a touch event and a hovering event (e.g., values including a voltage value or a current value as an analog value) are output differently from each other, in order to differently detect the touch event through the contact between the touch screen and the user's body or the touchable input unit, and the input event in a non-contact state (e.g., a hovering event). Further, the screen 190 differently outputs detected values (for example, a current value or the like) according to a distance between a position in the air where the hovering event is generated and the touch screen 190.

The touch screen 190 is implemented in, for example, a resistive type, a capacitive type, an infrared type, or an acoustic wave type.

The touch screen 190 may include at least two touch screen panels, which can detect touches or approaches of the user's body and the touchable input unit separately, in order to sequentially or simultaneously receive the inputs by the user's body and the touchable input unit. The at least two touch screen panels provides different output values to the touch screen controller, and the touch screen controller differently recognizes the values input from the at least two touch screen panels and identifies whether the input from the touch screen 190 corresponds to the input by the user's body or the input by the touchable input unit.

More specifically, the touch screen 190 is formed with a structure in which a panel that detects an input through the input unit 168 by using a change in an induced electromotive force and a panel that detects contact through a finger on the touch screen are attached to each other, or are spaced slightly apart from each other and stacked on one another. The touch screen 190 includes a plurality of pixels and displays an image through the pixels. The touch screen 190 uses a Liquid Crystal Display (LCD), an Organic Light Emitting Diode (OLED), or a Light Emitting Diode (LED).

The touch screen 190 includes a plurality of sensors that detect, when the input unit 168 touches a surface of the touch screen 190 or approaches within a predetermined range from the touch screen 190, a position where the input unit 168 is located. The plurality of sensors are formed with a coil structure, and in a sensor layer formed of the plurality of sensors, the sensors are arranged in a predetermined pattern and form a plurality of electrode lines. When a contact is generated on the touch screen 190 through the input unit 168, a detection signal in which a waveform is changed due to a magnetic field between the sensor layer and the input unit is generated by such a structure. Then, the touch screen 190 transmits the generated detection signal to the controller 110. Further, when the finger contacts the touch screen 190, the touch screen 190 transmits, to the controller 110, a detection signal generated due to capacitance. A distance between the input unit 168 and the touch screen 190 is grasped through an intensity of a magnetic field generated by a coil 430. Hereinafter, a process of configuring an intensity of a vibration will be described.

The touch screen controller 195 converts an analog signal received from the touch screen 190 to a digital signal (for example, X and Y coordinates) and then transmits the digital signal to the controller 110. The controller 110 controls the touch screen 190 by using the digital signal received from the touch screen controller 195. For example, the controller 110 allows a short-cut icon or an object displayed on the touch screen 190 to be selected or executed in response to a touch event or a hovering event. The touch screen controller 195 may also be included in the controller 110.

The touch screen controller 195 identifies a distance between the touch screen 190 and a position in the air where the hovering event is generated by detecting a value (for example, a current value or the like) output through the touch screen 190, converts the identified distance value to a digital signal (for example, a Z coordinate), and then provides the converted digital signal to the controller 110.

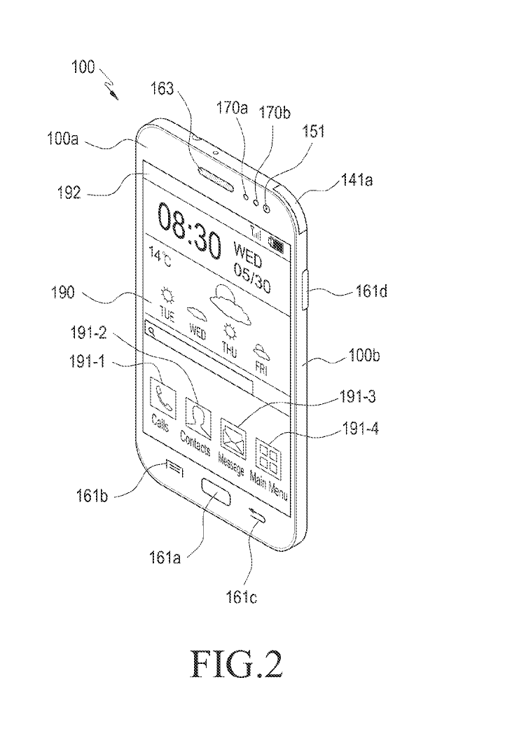

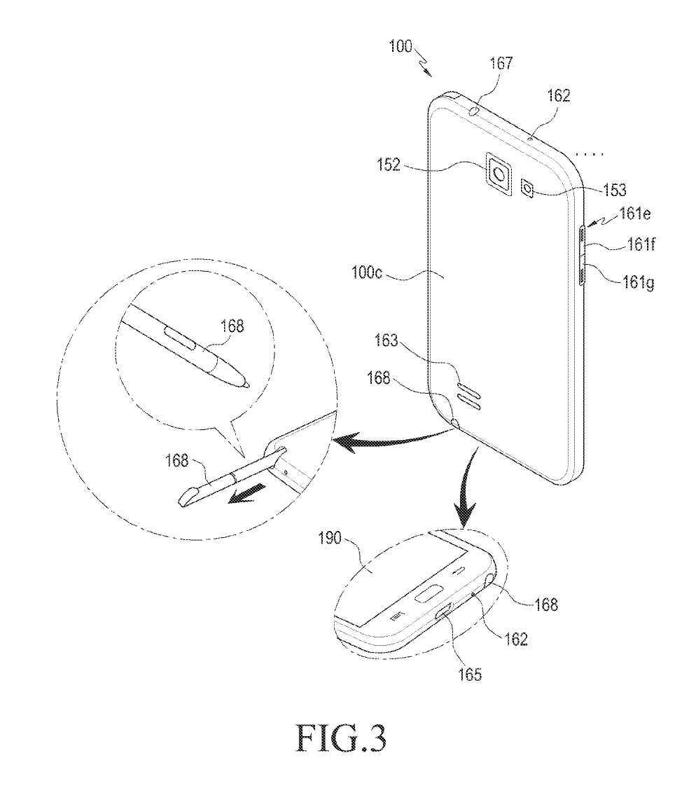

FIG. 2 illustrates a front perspective view of a portable terminal according to an embodiment of the present invention, and FIG. 3 illustrates a rear perspective view of a portable terminal according to an embodiment of the present invention.

Referring to FIGS. 2 and 3, the touch screen 190 is disposed in a center of a front surface 100a of the portable terminal 100. The touch screen 190 has a large size to occupy most of the front surface 100a of the portable terminal 100. FIG. 2 illustrates an example where a main home screen is displayed on the touch screen 190. The main home screen is a first screen displayed on the touch screen 190 when power of the portable terminal 100 is turned on. Further, when the portable terminal 100 has different home screens of several pages, the main home screen is a first home screen of the home screens of several pages. Short-cut icons 191-1, 191-2, and 191-3 for executing frequently used applications, a main menu switching key 191-4, time, weather, and the like are displayed on the home screen. The main menu switch key 191-4 displays a menu screen on the touch screen 190. At the top end of the touch screen 190, a status bar 192 is formed and indicates the status of the portable terminal 100 such as the battery charge status, the intensity of a received signal and current time.

A home button 161a, a menu button 161b, and a back button 161c are formed at a lower portion of the touch screen 190.

The main home screen is displayed on the touch screen 190 through the home button 161a. For example, when the home key 161a is touched in a state where a home screen different from the main home screen or the menu screen is displayed on the touch screen 190, the main home screen is displayed on the touch screen 190. Further, when the home button 191a is touched while applications are executed on the touch screen 190, the main home screen is displayed on the touch screen 190. Further, the home button a may be used to display recently used applications or a task manager on the touch screen 190.

The menu button 161b provides a connection menu which can be used on the touch screen 190. The connection menu includes a widget addition menu, a background changing menu, a search menu, an editing menu, an environment setup menu, and the like.

The back button 161c displays a screen which was executed just before the currently executed screen or terminates a most recently used application.

The first camera 151, an illumination sensor 170a, and a proximity sensor 170b are disposed on edges of the front surface 100a of the portable terminal 100. The second camera 152, the flash 153, and the speaker 163 are disposed on a rear surface 100c of the portable terminal 100.

For example, a power/reset button 160a, a volume button 161b, a terrestrial DMB antenna 141a for receiving a broadcast, and one or more microphones 162 are disposed on a side surface 100b of the portable terminal 100. The DMB antenna 141a is fixed to the portable terminal 100 or may be formed to be detachable from the portable terminal 100.

The portable terminal 100 has the connector 165 arranged on a lower side surface thereof. A plurality of electrodes are formed in the connector 165, and the connector may be connected to an external device through a wire. The earphone connecting jack 167 is formed on an upper side surface of the portable terminal 100. Earphones are inserted into the earphone connecting jack 167.

The input unit 168 is mounted to a lower side surface of the portable terminal 100. The input unit 168 is inserted into the portable terminal 100 to be stored in the portable terminal 100, and withdrawn and separated from the portable terminal 100 when being used.

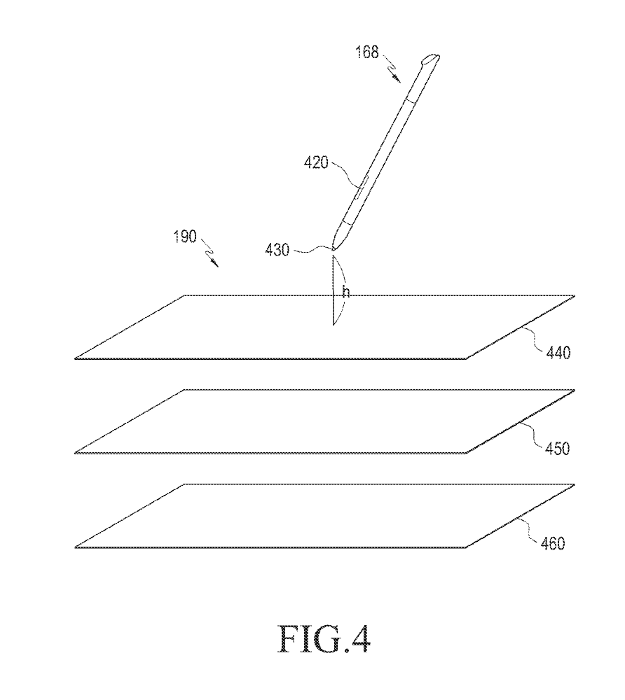

FIG. 4 is an internal cross-sectional view of the input unit and the touch screen according to an embodiment of the present invention.

As illustrated in FIG. 4, the touch screen 190 includes a display panel 450, a first touch panel 440, and a second touch panel 460. The display panel 450 is a panel such as a Liquid Crystal Display (LCD) panel or an Active Matrix Organic Light Emitting Diode (AMOLED) panel, and displays various operation statuses of the portable terminal 100, various images according to an application execution and a service, and a plurality of objects.

The first touch panel 440 is a capacitive type touch panel, which is coated with a dielectric in which both sides of a glass are coated with a metal conductive material (for example, an Indium Tin Oxide (ITO) film or the like) so that the first touch panel 190b allows a current to flow in the glass surface and stores a charge. When a user's finger is touched on a surface of the first touch panel 440, a predetermined amount of electric charge moves to a touched position due to a static electricity, and the first touch panel 440 detects the touched position through recognizing a variation in a current according to the movement of the electric charge. All touches that may cause static electricity can be detected through the first touch panel 440.

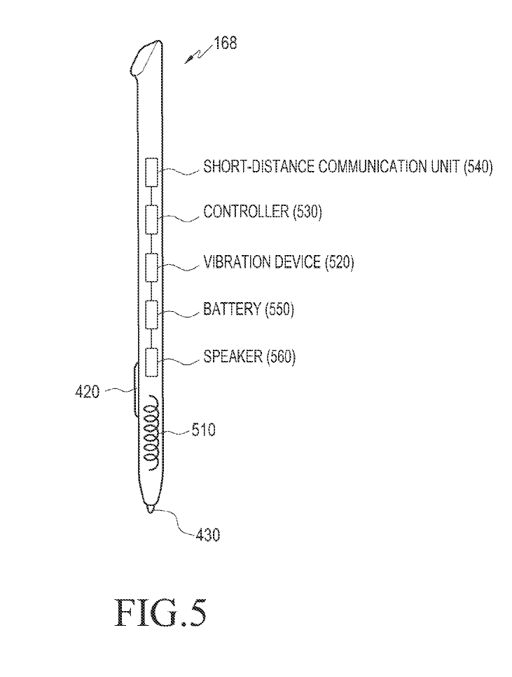

The second touch panel 460 is an Electronic Magnetic Resonance (EMR) type touch panel, which includes an electromagnetic induction coil sensor having a grid structure in which a plurality of loop coils are arranged in a predetermined first direction and a second direction crossing the first direction and an electronic signal processor for sequentially providing an AC signal having a predetermined frequency to each loop coil of the electromagnetic induction coil sensor. When the input unit 168 having a resonant circuit therein is located near the loop coil of the second touch panel 460, a magnetic field transmitted from the corresponding loop coil generates a current based on mutual electromagnetic induction in the resonant circuit within the input unit 168. An induction magnetic field is generated, based on the current, from a coil that configures a resonance circuit within the input unit 168, and the second touch panel 460 detects the induction magnetic field from the loop coil in a signal reception state and thus the portable terminal 100 detects a hovering position of the input unit 168, a touch position, and a height (h) from the first touch panel 450 to the nib 430 of the input unit 168. It will be readily understood by those skilled in the art to which the present invention pertains that the height (h) from the first touch panel 450 of the touch screen 190 to the nib 430 may vary depending on the performance or structure of the portable terminal 100. If an input unit causes a current based on electromagnetic induction through the second touch panel 460, a hovering event and a touch can be detected, and it will be described that the second touch panel 460 is to be used only for detection of the hovering event or the touch by the input unit 168. The input unit 168 may be referred to as an electromagnetic pen or an EMR pen. Further, the input unit 168 may be different from a general pen that does not include the resonance circuit detected through the first touch panel 450. The input unit may include a button 420 that may change an electromagnetic induction value generated by a coil that is disposed, in an interior of a penholder, adjacent to the nib 430. The input unit 168 will be more specifically described below with reference to FIG. 5.

A touch screen controller 195 includes a first touch panel controller and a second touch panel controller. The first touch panel controller converts an analog signal received from the first touch panel 450 by a detection of a finger to a digital signal (for example, X, Y, and Z coordinates) and transmits the converted digital signal to the controller 110. The second touch panel controller converts an analog signal, received from the second touch panel 460 through detection of a hovering event or a touch of the input unit 168, into a digital signal, and transmits the digital signal to the controller 110. The controller 110 controls the display panel 440, the first touch panel 450, and the second touch panel 460 by using the digital signals received from the first and second touch panel controllers. For example, the controller 110 displays a screen in a predetermined form on the display panel 440 in response to a hovering or a touch by the finger, the pen, or the input unit 168.

The first touch panel detects the touch by the user's finger or the pen, and the second touch panel detects the hovering or the touch by the input unit 168 in the portable terminal 100. Accordingly, the controller 110 of the portable terminal 100 can differently detect the touch by the user's finger or the pen and the hovering or the touch by the input unit 168. While only one touch screen is illustrated in FIG. 4, the present invention may include a plurality of touch screens, without being limited thereto. The plurality of touch screens may be disposed in housings separately, and may be connected with each other by hinges, or the plurality of touch screens may be disposed in a single housing. The plurality of touch screens include the display panel and the at least one touch panel, as illustrated in FIG. 4.

FIG. 5 is a block diagram illustrating the input unit according to an embodiment of the present invention.

Referring to FIG. 5, the input unit (for example, a touch pen) includes a penholder, a nib 430 arranged at an end of the penholder, the button 420 that can change an electromagnetic induction value generated by a coil 510 arranged within the penholder in an area adjacent to the nib 430, a vibration device 520 that vibrates when a hovering input effect is generated, a controller 530 that analyzes a control signal received from the portable terminal 100 by a hovering with the portable terminal 100 and controls a vibration intensity and a vibration cycle of the vibration device 520 in order to provide a haptic effect to the input unit 168 according to the analyzed control signal, a short distance communication unit 540 that performs short distance communication with the portable terminal 100, and a battery 550 that supplies power for the vibration of the input unit 168. The input unit 168 may further include a speaker 560 that outputs a sound corresponding to the vibration intensity and the vibration period of the input unit 168.

The input unit 168 having such a configuration supports a static induction type. When a magnetic field is caused at a predetermined point of the touch screen 190 by the coil 510, the touch screen 190 is configured to recognize a touch point through detecting a position of the corresponding magnetic field.

The speaker 560 outputs sounds corresponding to various signals (for example, a wireless signal, a broadcasting signal, a digital audio file, or a digital video file) from the mobile communication module 120, the sub communication module 130, or the multimedia module 140 included in the portable terminal 100 according to a control of the controller 530. The speaker 560 may also output sounds corresponding to functions that the portable terminal 100 performs (e.g., a button manipulation tone corresponding to a telephone call, or a call connection tone), and one or a plurality of speakers 560 may be installed at a proper position or positions of a housing of the input unit 168.

The input unit 168 having such a configuration supports a static induction type. When a magnetic field is caused at a predetermined point of the touch screen 190 by the coil 510, the touch screen 190 is configured to recognize a touch point through detecting a location of the corresponding magnetic field.

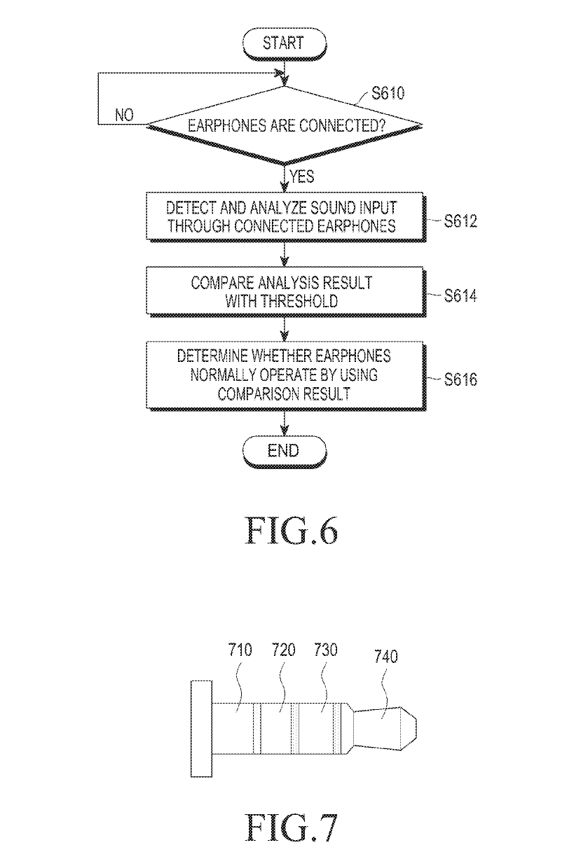

Hereinafter, the process of determining whether earphones of the portable terminal normally operate according to an embodiment of the present invention will be described in detail with reference to FIGS. 6 to 8.

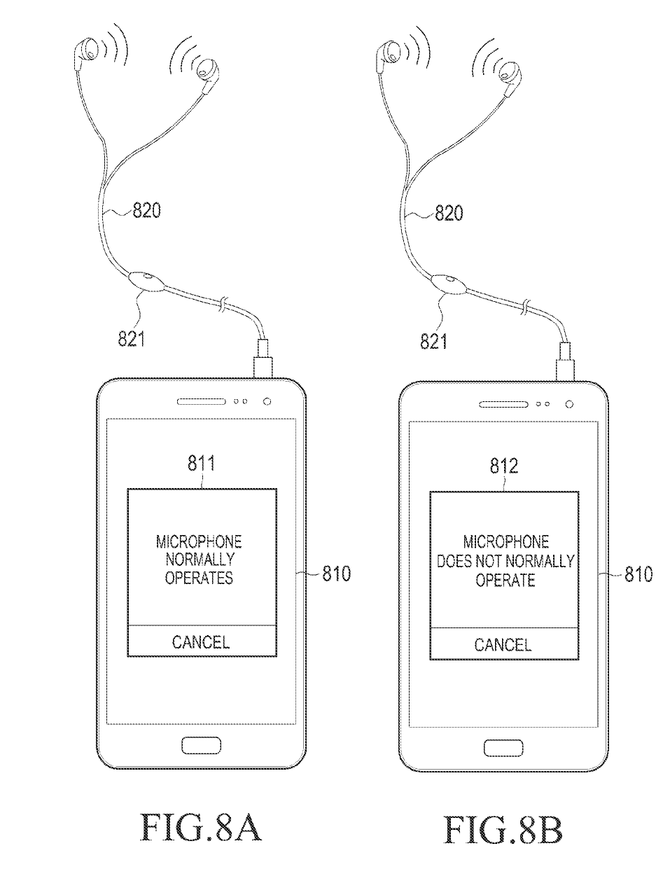

FIG. 6 is a flowchart illustrating a process of determining whether earphones of the portable terminal normally operate according to an embodiment of the present invention. FIG. 7 illustrates an example of a structure of an earphone jack according to an embodiment of the present invention. FIGS. 8A and 8B illustrate examples of outputting information on whether the earphones normally operate according to an embodiment of the present invention.

When the earphones are connected in step S610, a sound input through the earphones is detected and analyzed in step S612. A structure of an earphone jack according to an embodiment of the present invention is illustrated in FIG. 7. Referring to FIG. 7, the earphone jack includes a ground terminal 710, a microphone terminal 720, a right sound terminal 730, and a left sound terminal 740. Earphones having this structure are referred to as 4 pole earphones. The ground terminal 710 includes a switching terminal. The ground terminal 710 and the switching terminal are connected to the same pole line of the earphones. The microphone terminal performs a function of transmitting a sound input through a microphone 821 of the earphones to the portable terminal. The right sound terminal 730 and the left sound terminal 740 transmit a sound to the earphones to output the sound. Further, the earphones may sequentially include the ground terminal 710, the microphone terminal 720, the right sound terminal 730, and the left sound terminal 740 as described above, and also may have various arrangements of the above terminals.

When the earphones 820 are inserted into or connected to the earphone connecting jack 167 (see FIGS. 1 and 3) of the portable terminal 100, the portable terminal 100 detects the insertion or the connection. The portable terminal 100 activates the attachment/detachment recognition switch 169 (see FIG. 1) in accordance with the insertion of the earphones 820 of the portable terminal 100 into the earphone connecting jack 167. The attachment/detachment recognition switch 169 is arranged at one area of the portable terminal 100 into which the earphones 820 are inserted to be directly/indirectly connected to the earphones 820 when the earphones 820 are inserted. Accordingly, the attachment/detachment recognition switch 169 generates a signal corresponding to the attachment or the detachment of the earphones 820 based on the direct or indirect contact with the input unit 168 and provides the generated signal to the controller 110 according to a control of the controller 110. Further, the portable terminal determines whether the microphone 821 is included in the earphones 820. In addition, the portable terminal 100 determines whether the microphone 821 included in the earphones 820 normally operates. As described above, the portable terminal 100 detects a sound input through the earphones and analyzes the detected sound to determine at least one of whether the microphone 821 is included in the earphones 820 and whether the microphone 821 included in the earphones 820 normally operates. When no voice signal is input after the insertion of the earphones 820, the portable terminal 100 determines that the microphone is not installed in the earphones 820. When a voice signal is input after the insertion of the earphones 820 but the voice signal is similar to noise, the portable terminal 100 determines that the microphone installed in the earphones 820 does not normally operate. The controller 110 of the portable terminal analyzes the detected sound by calculating at least one of a peak value, a power value, an SNR, and an RMS of the detected sound, to measure a level of the detected sound. The measurement of the level may be performed by the portable terminal 100 to determine whether the microphone is included in the earphones and whether the microphone normally operates. Further, the present invention may include various methods to detect a sound as well as to calculate the aforementioned peak value, power value, SNR, and RMS.

The portable terminal then compares an analysis result with a predetermined threshold in step S614. The analysis result is obtained by calculating at least one of the peak value, the power value, the SNR, and the RMS of the detected sound to measure a level of the sound, by the portable terminal. Then, the portable terminal compares the analysis result with a predetermined threshold. That is, the portable terminal analyzes what the peak value of the detected sound is, whether the peak value exceeds a predetermined threshold, and how many peak values exceeding the predetermined threshold exist, and compares a result of the analysis with a predetermined threshold corresponding to an attribute of the result of the analysis. Similarly, the portable terminal analyzes power and signal intensity of the detected sound and compares a result of the analysis with a predetermined threshold. Further, the portable terminal analyzes an SNR or an RMS of the detected signal and compares a result of the analysis with a predetermined threshold. As described above, the predetermined threshold according to each detection method may be differently configured according to the detection method and may be variably controlled.

The portable terminal determines whether the earphones normally operate by using a comparison result in step S616. The portable terminal determines whether the microphone included in the earphones normally operates or not, as well as determines whether the earphones normally operate through the use of the comparison result. When the analysis result exceeds a first predetermined threshold as the comparison result in step S614, the portable terminal determines that the microphone is installed in the earphones. When the analysis result exceeds a second predetermined threshold, the portable terminal determines that the microphone normally operates. The first predetermined threshold and the second predetermined threshold have different values from each other. The first predetermined threshold for determining whether the microphone is installed in the earphones is smaller than the second predetermined threshold for determining whether the microphone normally operates. Whether the microphone included in the earphones normally operates may be determined by the SNR of the input sound. When the calculated SNR exceeds a predetermined threshold, it is determined that the microphone normally operates. Further, the portable terminal may determine whether the microphone normally operates through various methods including using the RMS, and the like, as well as the aforementioned SNR. Further, the portable terminal outputs the determination result to at least one of the earphones and a screen of the portable terminal so that the user to recognize whether the microphone is installed in the earphones or whether the microphone normally operates through a popup window display on the touch screen or a sound output to the earphones. Further, the present invention may include various methods of allowing the user to recognize whether the microphone is installed in the earphones or whether the microphone normally operates through a vibration as well as the aforementioned popup window and sound output.

FIG. 8A illustrates an example of an output indicating a normal operation of the microphone included in the earphones according to an embodiment of the present invention, and FIG. 8B illustrates an example of an output indicating an abnormal operation of the microphone included in the earphones according to an embodiment of the present invention.

As illustrated in FIG. 8A, when the microphone 821 included in the earphones 820 normally operates, the portable terminal displays a popup window 811 informing the normal operation on the touch screen 810 or outputs a sound informing the normal operation. The popup window and the sound output may be made simultaneously or separately with a predetermined time difference therebetween. Similarly, as illustrated in FIG. 8B, when the microphone 821 included in the earphones 820 does not normally operate, the portable terminal displays a popup window 812 informing the abnormal operation on the touch screen 810 or outputs a sound informing the abnormal operation. The popup window and the sound output may be made simultaneously or made separately with a predetermined time difference therebetween. Further, the portable terminal may inform the user whether the microphone is installed in the earphones by using at least one of the sound output and the popup window display as described above.

It may be appreciated that the embodiments of the present invention may be implemented in software, hardware, or a combination thereof. Any such software may be stored, for example, in a volatile or non-volatile storage device such as a ROM, a memory such as a RAM, a memory chip, a memory device, or an IC, or a optical or magnetic recordable and machine (e.g., computer) readable medium such as a Compact Disc (CD), a Digital Video Disc (DVD), a magnetic disk, or a magnetic tape, regardless of its ability to be erased or its ability to be re-recorded. It can be seen that a memory which may be included in the mobile terminal corresponds to an example of the storage medium suitable for storing a program or programs including instructions by which the embodiments of the present invention are realized. Accordingly, the present invention includes a program that includes a code for implementing an apparatus or a method defined in any claim in the present specification and a machine-readable storage medium that stores such a program. Further, the program may be electronically transferred by a predetermined medium such as a communication signal transferred through a wired or wireless connection, and the present invention appropriately includes equivalents of the program.

Moreover, the above-described mobile terminal can receive the program from a program provision device which is connected thereto in a wired or wireless manner, and store the program. The program providing apparatus may include a memory for storing a program containing instructions for allowing the camera apparatus to perform a preset content protecting method and information required for the content protecting method, a communication unit for performing wired or wireless communication with the camera apparatus, and a controller for transmitting the corresponding program to the camera apparatus according to a request of the camera apparatus or automatically.

Although specific embodiments have been described in the detailed descriptions of the present invention, it is apparent that various modifications may be carried out without departing from the scope of the present invention. Therefore, the scope of the present invention should not be defined as being limited to the embodiments, but should be defined by the appended claims and equivalents thereof

What is claimed is:

1. A method for detecting an earphone connection by a portable terminal, the method comprising:
detecting a connection of earphones;
detecting and analyzing a sound input through the connected earphones; and
determining whether a microphone is installed in the earphones by comparing an analysis result with a first predetermined threshold.

2. The method of claim 1, wherein the analysis result is obtained by calculating at least one of a peak value, a power value, a Signal to Noise Ratio (SNR), and a Root Mean Square (RMS) of the detected sound.

3. The method of claim 1, wherein determining whether a microphone is installed in the earphones comprises determining that the microphone is installed in the earphones if the analysis result exceeds the first predetermined threshold.

4. The method of claim 1, further comprising determining whether the microphone normally operates by comparing the analysis result with a second predetermined threshold.

5. The method of claim 4, further comprises outputting a determination result of whether the microphone normally operates to at least one of the earphones and the portable terminal.

6. The method of claim 4, wherein it is determined that the microphone normally operates if the analysis result exceeds the second predetermined threshold.

7. A portable terminal for detecting an earphone connection, the portable terminal comprising:
an earphone connecting jack configured to connect the portable terminal and earphones; and
a controller configured to detect and analyze a sound input through the connected earphones, and to determine whether a microphone is installed in the earphones by comparing an analysis result with a first predetermined threshold.

8. The portable terminal of claim 7, wherein the analysis result is obtained by calculating at least one of a peak value, a power value, a Signal to Noise Ratio (SNR), and a Root Mean Square (RMS) of the detected sound by the controller.

9. The portable terminal of claim 7, wherein the controller is configured to determine that the microphone is installed in the earphones if the analysis result exceeds the first predetermined threshold.

10. The portable terminal of claim 7, wherein the controller is configured to determine whether the microphone normally operates by comparing the analysis result with a second predetermined threshold.

11. The portable terminal of claim 10, wherein the controller is configured to output a determination result of whether the microphone normally operates to at least one of the earphones and the portable terminal.

12. The portable terminal of claim 10, wherein the controller is configured to determine that the microphone normally operates if the analysis result exceeds the second predetermined threshold.

13. The portable terminal of claim 7, wherein the controller is configured to activate a module that detects a sound input through the microphone installed in the earphones if the earphones are connected.

14. A method for detecting an earphone connection by a portable terminal, the method comprising:
detecting an insertion of an earphones jack of earphones having a microphone into an earphone connecting jack;
detecting and analyzing a sound input through the microphone of the inserted earphones; and
determining whether the microphone normally operates by comparing an analysis result with a predetermined threshold.

15. The method of claim 14, wherein the analysis result is obtained by calculating at least one of a peak value, a power value, a Signal to Noise Ratio (SNR), and a Root Mean Square (RMS) of the detected sound.

16. The method of claim 14, wherein determining whether the microphone normally operates comprises determining that the microphone normally operates if the analysis result exceeds the predetermined threshold.

17. The method of claim 14, wherein a determination result of whether the microphone normally operates is provided to a user by using at least one of a sound output through the earphones and a popup display on a touch screen of the portable terminal.
